(19) United States
(12) Patent Application Publication
(10) Pub. No.: US 2011/0060923 A1
(43) Pub. Date: Mar. 10, 2011

(54) Port Power Control

(76) Inventors: Cary J. Hoffer, Albany, OR (US); Jordan Hoffer, Benton, OR (US)

(21) Appl. No.: 12/554,876

(22) Filed: Sep. 5, 2009

(51) Int. Cl. G06F 1/00

(52) U.S. Cl. 713/300

(57) ABSTRACT

A computing system can include a display to display a representation of the computing system and an image of a port. An input device can select the image of the port and a processor coupled to the display and the input device can associate the selected image of the port to a port on the computing system. An input output controller coupled to the processor can control power to the port.

### BACKGROUND

The Advanced Configuration and Power interface (ACPI) includes many system states, device states, processor states, and performance states. ACPI defines a large number of tables that provide the power interface between an ACPI-compliant operating system and system firmware. These allow description of system hardware in a platform-independent manner, and are presented as either fixed formatted data structures or in ACPI Machine Language (AML) to allow the Operating system to control the power states of the components in a system.

### BRIEF DESCRIPTION OF THE DRAWINGS

Some embodiments of the invention are described with respect to the following figures:

FIG. 1 is a graphic interface of a computing system according to an exemplary embodiment;

FIG. 2 is a computing system according to an exemplary embodiment;

FIG. 3 is a block diagram according to an exemplary embodiment;

FIG. 4 is a block diagram according to an exemplary embodiment;

FIG. 5 is a block diagram according to an exemplary embodiment; and

FIG. 6 is a flow diagram of a method according to an exemplary embodiment.

### DETAILED DESCRIPTION

ACPI can be used to control the system states, for example ACPI defines some possible states for the Computer System such as a G0 (working), G1 (sleeping), G2 (soft off), and G3 (mechanical off). The G1 state can be divided into four sub-states, for example, S1 (All processor caches are flushed, and the CPU(s) stop executing instructions; power to the CPU(s) and RAM is maintained; devices that do not indicate they must remain on may be powered down), S2 (The CPU is powered off), S3 (referred to as Standby, Sleep, or Suspend to RAM where RAM is still powered) and S4 (Hibernation where all content of main memory is saved to non-volatile memory such as a hard drive, and is powered down).

ACPI also defines device states. For example, the device states D0-D3 are device-dependent but a D0 state is a fully-on operating state, D1 and D2 are intermediate power-states whose definition varies by device, and D3 is an Off state where the device powered off and unresponsive to its data bus. In the intermediate states the device may have power to respond to requests that may wake up the device to put the device in a D0 fully-On operating state.

ACPI does not provide a graphic interface to allow the selection of device states for a device on the computing system. A component, for example a USB Port, can be constantly drawing power while waiting for a device to be connected. A USB controller draws power that is used to detect a USB device being connected to the USB Port. A USB port can operate by detecting a device when it is connected to the port and configure the device and the computing system for data transfer however this ability consumes power. The consumption of power can decrease the battery life of a portable computing system and increase the power usage of other computing systems, such as desktops and servers.

To reduce the power consumption or increase the battery life of a portable computing system the ports of a computing system may be turned off when it is not used to detect a device being connected to the port. A port is a hardware interface by which a computer can be connected to another device to communicate with the other device.

In one embodiment, a computing system can include a graphic interface to display an image of the computing system. An image of a port corresponding to a physical location of the port on the computing system can be indicated on the image of the computing system. The image of the port can be selected by an input device and power to the corresponding port can be controlled according to the selection. A controller can also control power to the port if a button is activated.

An input device can interact with the image of the computing system to turn off the ports that are not in use. The interaction by the user can be by using an input device to select a graphical representation of a port on the image of the computing system to turn the port off or on. The graphic interface can also be to indicate that the power to the port is controlled by a button and when the button is activated the power to the selected ports are controlled.

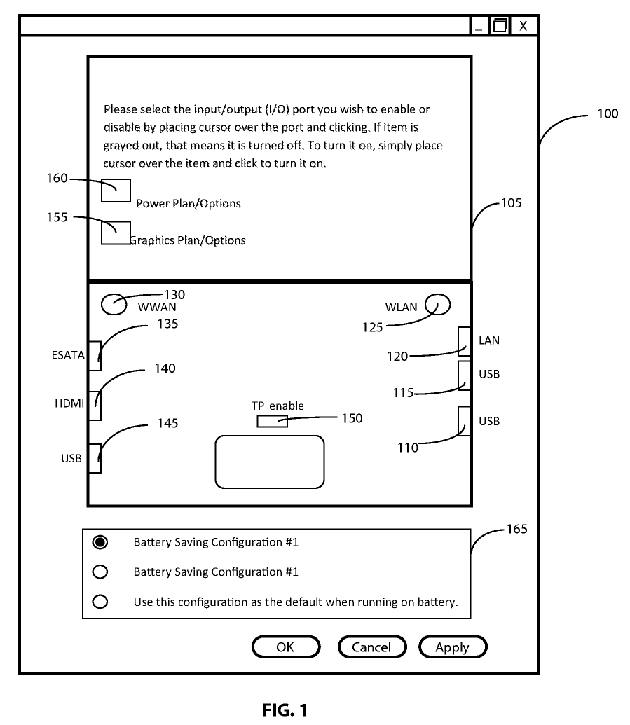

Referring to the figures, FIG. 1 is a graphic interface of a computing system according to an exemplary embodiment. The graphic interface 100 includes an image of a computing system 105. The computing system can be for example a notebook computer, a personal digital assistant (PDA), a desktop computer, or a server. The image of the computing system 105 represents the computing system that is generating the image. The image of the computing system 105 can include ports. The ports may be different types of ports, for example a port may be a USB port 110. Other ports may include USB ports 115, 145, LAN port 120, ESATA port 135, HDMI port 140, or other ports such as an IEEE 1394 port. Images representing other components may also be displayed for example the touch pad control 150, Wireless LAN control 125, and Wireless Wan Control 130. The image of the computing system may also include access to the ACPI settings including power options 160 and the Graphics options 155 for example.

The graphic interface can configure the computing system to operate on different configurations based on conditions in the computing system. For example, there can be a configuration for operating with power from a battery, and another configuration for operating with power from an external source such as an Alternating Current (AC) wall outlet. Another configuration may be for if the battery is below a programmed percentage of remaining battery life. For example if the battery is below 50% of remaining battery life the configuration may change from a configuration for operating from a battery over 50% of remaining battery life to a configuration for operating from a battery with less than 50% of remaining battery life.

The configurations may be set up differently. For example the configuration to operate from an external power source can be programmed to turn on all of the ports and components. A configuration to operate from a battery may not turn on all of the ports or components. For example the USB 110, USB 115, USB 145, LAN 120, ESATA 135, and HDMI 140 may be configured to be turned off since the ports may not be used to connect external components. For example if the computer is operating from a battery the LAN port 120 may not be connected to a network because the LAN port connects the computer to the network using a cable which would reduce the portability of a computing system.

In one embodiment the battery configuration can be selected in the configuration box 165. If a configuration is selected in the box the image of the computers display the ports that are on the computing system, indicating the ports that are turned on in the selected configuration and the ports that are turned off in the selected configuration. For example the ports that are turned on in a selected configuration may be highlighted while the ports that are turned off in a selected configuration may be grayed out. To change the setting of a port for selected configuration the image on the display representing port may be selected using an input device, such as a mouse, touch screen or keyboard for example.

In one embodiment the user can program a configuration that the computing system defaults to if the system is on battery. For example the USB port 110 may be turned on while the other USB ports 115 and 145 are turned off. The other configurations can be selected that may have more or less ports drawing power. For example another configuration may have all the ports receiving power. In one embodiment if a configuration causes a port to receive power and a device is detected as being connected to the port the port may continue to receive power if the configuration is changed to a configuration that does not power the port with a device connected or the computing system may prompt a user with whether to continue to supply power to the port. If the computing system prompts the user the user can determine if the device connected to the port is still going to be used or there is not going to be a further data transfer and the power to the port can be discontinued.

In some embodiments the configuration settings may include power options and graphic options. For example, some processors may have different state settings that can change the amount of power the processor draws from the power supply. A processor may have a first state setting where the processor operates at a first frequency and a second state setting where the processor operates at a second frequency, wherein the first frequency draws more power from the power supply than the second frequency. The power options for a configuration can be changed by accessing the power options if a configuration is being displayed and if another configuration is displayed the power options for that configuration can be changed by accessing the power options while the other configuration is displayed.

In some embodiments the configuration settings may include graphic options. For example, the back light for the display may be at full brightness in a configuration or may be at a brightness level that is lower than full brightness to conserve battery power. For example in a configuration when the computing system is operating on external power the display may be at a full brightness level and in a configuration when the computing system is operating from a battery the display be may at a level that is less than full brightness.

In one embodiment, the graphic interface may be a list of ports that the computer can control power to. For example the operating system of the computing system may determine the list of ports that the computing system can control power to by accessing the basic input output system (BIOS) of the computing system.

In one embodiment the graphic interface is preprogrammed in the computing system so that the components on the graphic interface are in a corresponding physical location on the computing system. In an alternative embodiment the graphic interface is selected by the user and the ports are moveable by the user to the location that corresponds to the physical location of the ports. For example on the first activation of the graphic interface a selection may be made between a list of ports or an image representing the physical location. There may be multiple images to select from for example an image of a notebook computer, a desktop computer, a tower computer, or a server. If an image is selected for the graphic interface, the ports may not be represented on the graphic interface in a location representing the physical location of the ports on the computing system. However, in one embodiment the ports can be moved to a location on the graphic interface to represent the port's physical location and the ports may be relabeled. The relabeling may include changing the image representing the port or may include changing the symbol that identifies the type of port.

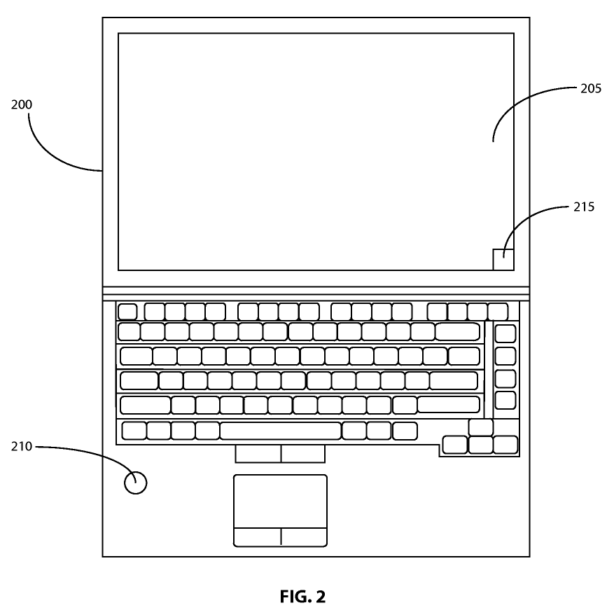

FIG. 2 is a computing system according to an exemplary embodiment. The computing system 200 can be a portable computer for example. In one embodiment the computing system 200 can include a button 210. The button may also be an icon 215 on the display 205 of the computing system 200.

In one embodiment, the button on the computing system 200 can be operated to cause the computing system to display the graphic interface. In another embodiment the button can cause the power configuration to change from a first power configuration to a second power configuration. For example if the computing system is running off of a battery and a default configuration for running on battery is enabled an activation of the button may put the computing system in another configuration. The other configuration may turn on ports or components that were not on in the default configuration or may turn off ports or components that were on in the default configuration. If there are multiple configurations programmed an activation of the button may change from a first configuration to a second configuration and an activation of the button in the second configuration may change the configuration to a third configuration or may return to the first configuration. If power was removed in the second configuration power may be restored if the button causes a return to the first configuration. If there are multiple configurations an indicator may be displayed on the display indicating which configuration the computing system is operating in. For example an icon on the display may change color based on the configuration or the icon may have a subscript indicating an identification number of the configuration. The button may also cause the graphic interface to display the ports that are going to be enabled and disabled in the configuration that the button is causing the computing system to enter.

The button may also have multiple functions, for example an activation of the button for less than a programmed period of time, such as 1 second, may cause the power configuration to change from a first power configuration to a second power configuration and an activation of the button for more than the programmed period of time, such as 1 second, may cause the graphic interface to be displayed. In one embodiment the button may change the power configuration from a first power configuration to a second power configuration and a second button may cause the graphic interface to be displayed.

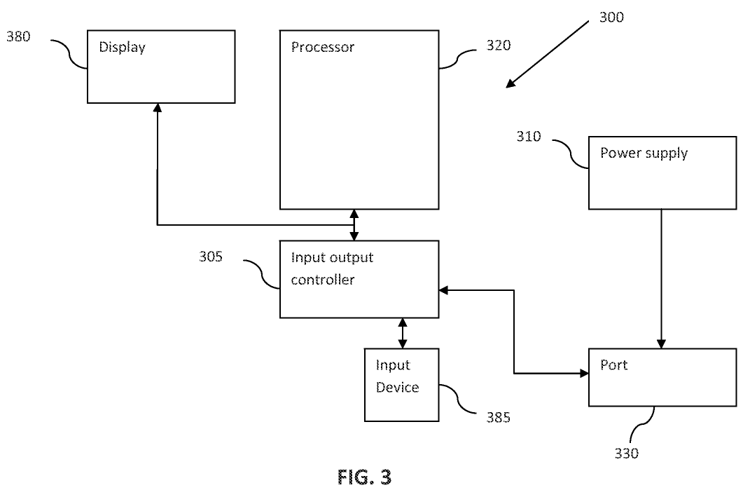

FIG. 3 is a block diagram according to an exemplary embodiment. The computing system 300 may include an input output controller 305. The input output controller can connect to a port 330 in the computing system 300. The input output controller 305 in one embodiment is coupled to the processor 320. The processor 320 can generate a signal to display an image on the display 380. The signal generated can display the graphic interface that may include an image representing the computing system and an image of a port on the computing system. A power supply 310 can connect to a port 330 to supply power that allows the port 330 to operate. The component may be for example, a USB port, an eSATA port, an express card port, an IEEE 1394 port, a LAN port or a Modem Port.

In one embodiment the input output controller 305 includes the port controller for example. If the input output controller 305 includes the controllers for the ports the input output controller may received a signal generated by the processor from the configuration of the computing system to turn off a component such as the port 330. The controller for a port may have different states, for example a USB controller may have an “ON” state, an “OFF” state or an intermediate state. A signal may be used to put the controller for a component in an Off state where there is no current draw from the component. The signal may be generated by the input output controller and transmitted to a controller for that component port. The controller for that component port may be part of the same integrated circuit as the input output controller or may be a separate integrated circuit.

In some embodiments the controlling of the ports power may be through an ACPI graphic interface that can provide control and information needed to perform device power management. An ACPI graphic interface can describe to an Operating System Configuration and Power management System (OSPM) the capabilities of all the devices ACPI can control. It can also give the Operating System (OS) the control methods used to set the power state or get the power status for each device. In one embodiment a power controller is on the integrated circuit of the input output controller 405.

The input output controller 305 may connect to the port 330 through a single data bus or multiple buses. If a port 330 is put in a lower power state, it may configure itself to draw no power from a power supply bus. If multiple component ports are on one bus the OS may track the state of all component ports on the bus, and will put the bus in the best power state based on the current device requirements on that bus. For example, if all devices on a bus are in the off state, the OS can put the bus in the off state.

A power configuration may be for example in the form of a table that is stored in a storage for example a non-volatile memory connected to the Input output controller 305 or in the BIOS 323. An input device 385 can select images of ports on the graphic interface to change the data stored on the table or tables to change the power configuration of the computing system, in one embodiment. A different portion of the table or a different table may indicate each power configuration for the computing system.

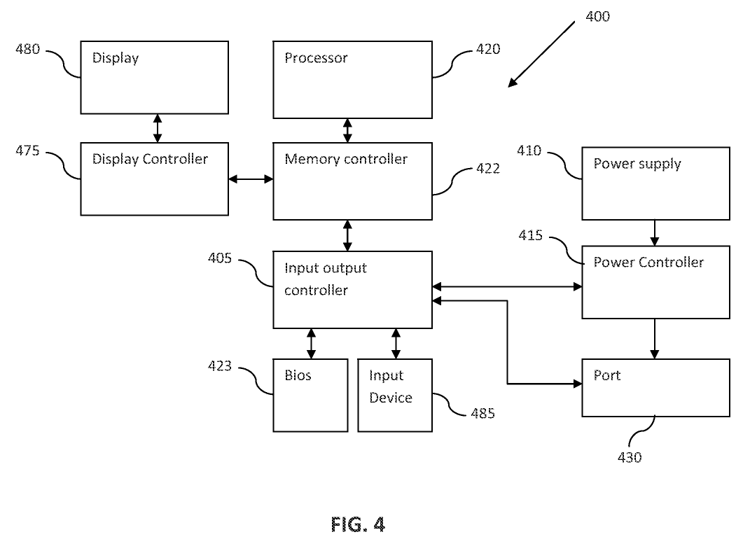

FIG. 4 is a block diagram according to an exemplary embodiment. In one embodiment a computing system 400 may turn the port 430 to its lowest power draw state but the port 430 may still draw power from the power supply 410. For example, a LAN port may have a power setting that responds to wake on LAN requests from the network even in its lowest setting. The power controller 415 may be able to remove the power from the port controller or the port that is still receiving power in an off state. The power controller 415 may not be between the power supply and a port, for example the power controller 415 may be between the power supply 410 and a port that still draws power in an off state and a port that does not draw power in an off state may be controlled by a signal generated in the input output controller 405 and transmitted to the port.

A power controller 415 may be connected to the input output controller 405. The power controller 415 may control the power supply to the components. The power controller 415 may also control power to components as well as the ports such as the wireless LAN.

In one embodiment the activation of a button can change the power configuration from a first power configuration to a second power configuration. The first power configuration and the second power configuration can be stored in the BIOS 423. The first and second configurations can be changed using the graphic interface by selecting an image of the port on the graphic interface on the display 480 generated by the display controller 475 using an input device 485. The input device 485 may be connected to the processor 420 through the memory controller 422 and the Input output controller 405. In the first power configuration for example the input output controller 405 may send a signal to the power controller 415 to remove power from the port 430. In a second power configuration for example the input output controller 405 may send a signal to a the power controller 415 to enable power to the port 430 or the input output controller 405 may send a signal to the port 430 to go to an on state.

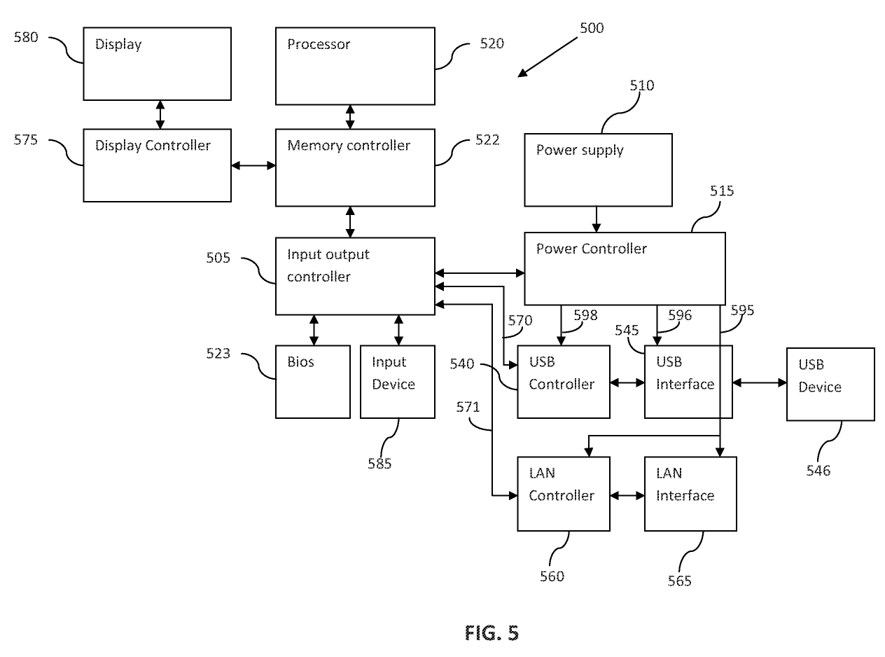

FIG. 5 is a block diagram according to an exemplary embodiment. In one embodiment a computing system 500 the port may include a communications port, port controller, and the port interface, for example a LAN port may include a communications port connected to a LAN controller 560 connected to a Network interface 565 that may connect to a network cable. The communications port may be part of the input output controller 505 integrated circuit. In one embodiment, the network interface 565 if supplied power from the power supply 510 through the power controller 515 may be able to wake the communications port or the LAN controller 560 if a network is connected to the network interface 565, however the power controller 515 may be able to remove all power to the network interface 565 until the port is activated by the input device 585 in the graphic interface on the display 580. The processor 520 can access a configuration that can be stored on the BIOS 523. The configuration may be changed by selecting, with the input device, an image of the USB or LAN port on the graphic interface that can be on the display 580 if generated by the display controller 575.

The input output controller 505 may connect to the ports through a single data bus or multiple data buses for example the USB ports may be on a first data bus 570 and the LAN ports may be on a second data bus 571. If a port, for example the network interface 565, is put in a lower power state, it may configure itself to draw no power from a power bus 595. If multiple component ports are on a power bus the OS may track the state of all component ports on the bus, and will put the bus in a power state based on the current device requirements on that bus. For example, if the network interface 565 and the LAN controller 560 are on a bus and both are in the off state, the OS can put the power bus 595 in the off state. If the components are on different buses for example the USB controller 540 is on power bus 598 and the USB interface 545 is on power bus 596. For example, a device may have a communication port connected to a power supply and the communication port is connected to a port controller such as a USB controller, the USB controller can be connected to a port interface which can be connected to a USB device 546. A USB device may be for example a printer, storage drive, keyboard, pointing device or another USB device. The communications port, port controller, and the port interface can have the power controlled to them separately and if the interface notifies the OS that the power to a port such as the USB port should be turned off the OS in one embodiment may decide to turn off power to the port interface the port controller and the communications port or a combination.

In one embodiment the graphic interface may be used to control which ports are going to receive power but the OS and ACPI may determine if the communications port, the port controller, or the port interface are all turned off if the port is turned off in the graphic interface.

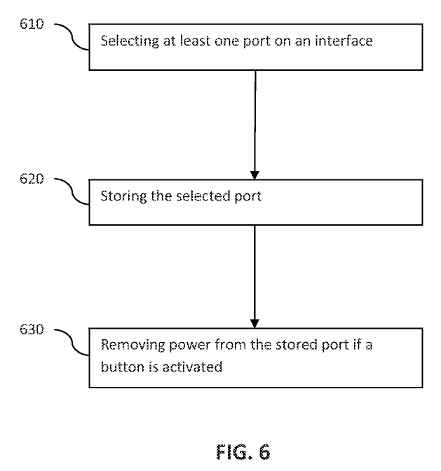

FIG. 6 is a flow diagram of a method according to an exemplary embodiment. The method 600 begins by selecting at least one port on a graphic interface to be powered (at 610). The graphic interface may be showing a power configuration for a computing system. The graphic interface may be able to display alternative power configurations for the computing system.

The selected port is stored (at 620). The selected port can be stored in the power configuration table. If the port is powered the port can communicated with the other components of the computing system and devices connecting to the selected port. If the power configuration of the computer system is change to a configuration where the stored port is not a selected port to be powered, then the power is removed from the stored port (at 630). The power configuration may be changed by activating a button or the power configuration may be changed by an event such as changing the computing systems power supply from an external source to a source such as a battery.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, just to name a few. Other new and various types of computer-readable media may be used to store and the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computing system comprising:
a display to display a representation of the computing system and an image of a port;
an input device to select the image of the port;
a processor coupled to the display and the input device to associate the selected image of the port to a port; and
an input output controller coupled to the processor to control power to the port.

2. The system of claim 1, further comprising a storage to store power configuration information.

3. The system of claim 2, wherein the configuration information is changed by selecting the image of the port with the input device.

4. The system of claim 3, further comprising a button to change the computing system from a first stored power configuration to a second stored power configuration.

5. The system of claim 1, further comprising a button to control the power to the port by controlling the input output controller.

6. The system of claim 1, further comprising a power controller connected to the input output controller to control to the port from a power supply.

7. The system of claim 1, further comprising a device to connect to the port.

8. The system of claim 1, further comprising basic input output system (BIOS) to store a list of ports that the input output controller can control power to.

9. The system of claim 1, further comprising storing multiple images to represent the computer system to select one for the representation of the computing system.

10. A method of power control in a computing system, comprising:
selecting a port on a graphic interface generated by the computing system;
storing the selection of the port; and
removing power from the selected port if a button to control power to the selected ports is activated.

11. The method of claim 10, further comprising displaying an image representing the computing system in the graphic interface.

12. The method of claim 10, further comprising displaying an image representing a port on the computing system in the graphic interface.

13. The method of claim 10, further comprising displaying the graphic interface if the button is activated for at least a programmed period of time.

14. The method of claim 10, further comprising restoring power to the selected port if the button is activated a second time.

15. The method of claim 10, further comprising accessing the stored selection of the port if the button is activated.

16. A computer readable medium comprising instructions that if executed cause a processor to:
generate a list of ports on a computing system;
display the list of ports on the computing system;
store a list of selected ports; and
disconnect power to the ports identified by the list of selected ports if a signal is received that a button is activated.

17. The computer readable medium of claim 16 further comprising instructions to power the ports identified by the list of selected ports if a button is activated a second time.

18. The computer readable medium of claim 16 further comprising instructions to access the list of ports indicating the power control for the ports.

19. The computer readable medium of claim 16 further comprising instructions to transmit data to an input output controller that will disconnect power from the ports identified by the list of selected ports.
